(19) United States
(12) Patent Application Publication
(10) Pub. No.: US 2011/0193866 A1
(43) Pub. Date: Aug. 11, 2011

(54) DATA INPUT SYSTEM

(76) Inventors: Emily J. Estes, Evans, CO (US); Erin R. Estes, Evans, CO (US); Michael E. Estes, Evans, CO (US)

(21) Appl. No.: 13/022,725

(22) Filed: Feb. 8, 2011

Related U.S. Application Data
(60) Provisional application No. 61/302,935, filed on Feb. 9, 2010.

(51) Int. Cl. G06F 3/02; G06T 11/00

(52) U.S. Cl. 345/467; 345/169

(57) ABSTRACT

Disclosed is an apparatus with a thumb-sized keyboard. The keyboard has at least one key for every letter of an alphabet. The apparatus also has an interface to couple a first indication of a first character associated with a first keystroke on the keyboard to a computer in real-time when the interface is in communication with the computer. The apparatus also has a memory interface to couple a second indication of a second character associated with a second keystroke on the keyboard to a removable memory device. The apparatus may communicate with a computer using a wireless communication link. The apparatus may communicate keystrokes on the thumb-sized keyboard to the computer such that the computer may register and display characters associated with the keystrokes as if they had been made on an attached keyboard.

### CROSS-REFERENCE TO RELATED APPLICATION

This application is based upon and claims priority to U.S. provisional application Ser. No. 61/302,935, filed Feb. 9, 2010, by Emily J. Estes et al., entitled “Data Input System.” The entire content of this application is specifically incorporated herein by reference for all that it discloses and teaches.

### BACKGROUND OF THE INVENTION

The increasing popularity of mobile computing devices, such as two-way pagers, personal digital assistants (PDAs) has contributed to the increased use of thumb-sized keyboards (e.g., keyboards that are small and designed to primarily be manipulated by the thumbs.) For example, it has been estimated that as many as 135 billion mobile text messages were sent in just the first quarter of 2004.

In the United States, texting is widely popular among the ages of 13-22 years old. However, it is increasing among adults and business users as well. The age that a child receives his/her first cell phone has also decreased, making text messaging a very popular way of communication for all ages. At least one survey found that 80% of United States mobile phone users text. The split by age group is as follows: 13-27's: 87% text, 15-37's 73% text, 28-39's: 44% text, 40-49's: 18% text. The amount of texts being sent in the United States has gone up over the years as the price has gone down to an average of $0.10 per text sent and received. These texts are often input to mobile phones using mini-QWERTY style keyboards.

### SUMMARY OF THE INVENTION

An embodiment of the invention may therefore comprise an apparatus, comprising: a thumb-sized keyboard, said keyboard having at least one key for every letter of an alphabet; an interface to couple a first indication of a first character associated with a first keystroke on said keyboard to a computer in real-time when said interface is in communication with said computer; and, a memory interface to couple a second indication of a second character associated with a second keystroke on said keyboard to a removable memory device.

An embodiment of the invention may therefore further comprise a method of providing input to a computer, comprising: receiving an indication of a keystroke associated with a first character from a thumb-sized keyboard, said keyboard having at least one key for every letter of an alphabet; coupling, via an interface, said first indication to a computer in real-time while said interface is in communication with said computer; and, coupling, to a removable memory device via a memory interface, a second indication of a second character associated with a second keystroke on said keyboard.

### BRIEF DESCRIPTION OF THE DRAWINGS

FIG. 1 is an illustration of a data input device.

FIG. 1A is an illustration of the operation of a data input device.

FIG. 2 is an illustration of a wireless data input device.

FIG. 3 is an illustration of a data input device with a display.

FIG. 4 is an illustration of a wireless data input device with a display.

FIG. 5 is a block diagram illustrating a data input system.

FIG. 6 is a block diagram illustrating a data input system.

FIG. 7 is a block diagram illustrating a wireless data input system.

FIG. 8 is a block diagram illustrating a wireless data input system.

FIG. 9 is a flowchart illustrating a method of providing input to a computer.

FIG. 10 is a flowchart illustrating a method of providing real-time input to a computer.

FIG. 11 is a flowchart illustrating a method of providing real-time input to a computer via a cellular telephone network.

FIG. 12 is a flowchart illustrating a method of providing stored input to a computer.

FIG. 13 is a flowchart illustrating a method of providing a real-time input service.

FIG. 13 is a flowchart illustrating a method of providing a real-time input service.

FIG. 14 is a flowchart illustrating a method of providing input to a computer using simple messaging service (SMS) protocol.

FIG. 15 is a block diagram of a computer system.

### DETAILED DESCRIPTION OF THE EMBODIMENTS

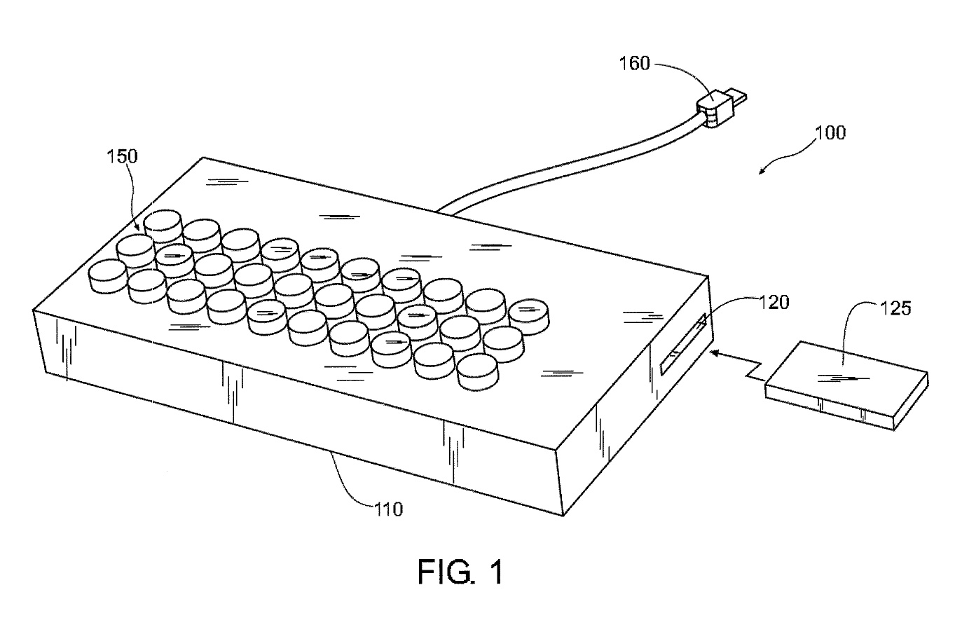

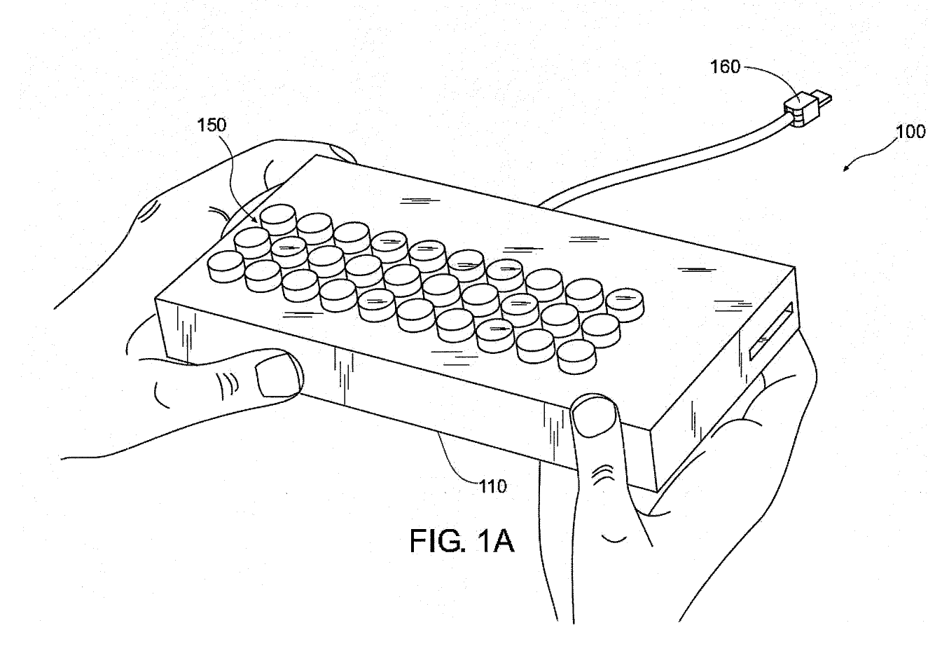

FIG. 1 is a block diagram of a data input device. In FIG. 1, data input system 100 comprises data input device 110 and removable memory 125. Data input device 110 includes removable memory interface 120, thumb-sized keyboard 150, and Universal Serial Bus (USB) interface 160.

Thumb-sized keyboard 150 (a.k.a., a thumb keyboard, or a thumbboard), may be a type of keyboard commonly found on PDAs, mobile phones, and PDA phones. Thumb-sized keyboard 150 may have a familiar layout to an ordinary keyboard. Thus, thumb-sized keyboard 150 may have at least one key for every letter of an alphabet.

The inputting surface of thumb-sized keyboard 150 is should be relatively small. Thumb-sized keyboard 150 is intended to be typed on using the available thumbs for inputting, while holding the device. Thumb-sized keyboard 150 may also be known as a mini-QWERTY keyboard. It should be understood, however, that thumb-sized keyboard 150 may have other key arrangements. For example, thumb-sized keyboard 150 may follow the Dvorak key arrangement, or other key arrangements designed for non-English languages (e.g., katakana).

Removable memory 125 may comprise flash memory. Flash memory is non-volatile computer storage that can be electrically erased and reprogrammed. Flash memory is primarily used in memory cards and USB flash drives for general storage and transfer of data between computers and other digital products. Flash memory is typically a type of EEPROM (Electrically Erasable Programmable Read-Only Memory) that is erased and programmed in large blocks.

Since flash memory is non-volatile, no power is needed to maintain the information stored in the chip. In addition, flash memory offers fast read access times. Flash memory also offers better kinetic shock resistance than hard disks. Flash memory may be packaged in a “memory card,” thus making it durable. Some flash memories can withstand intense pressure, extremes of temperature, and even immersion in water. Removable memory 125 may include one or more of the following types of flash memory devices: CompactFlash, SmartMedia, MultiMediaCard, Secure Digital, Memory Stick, xD, and USB flash drive. Removable memory 125 may include other types of non-volatile storage.

Removable memory interface 120 provides electrical connections between data input device 110 and removable memory 120. Removable memory interface 120 may be commonly referred to as a “slot” (e.g., SD slot) or “port” (e.g., USB port). For example, if removable memory interface 120 is compatible with Secure Digital memory cards, it may be referred to as a “Secure Digital slot.” Thus, removable memory interface 120 may interface with or more of CompactFlash, SmartMedia, MultiMediaCard, Secure Digital, Memory Stick, xD, and a USB flash drive. Removable memory interface 120 may interface with other types of non-volatile storage.

For data input device 110 to communicate with a computer, it may be connected to a computer. Typically, this is done by plugging USB interface 160 into a port built into the computer. Like other plug-in devices, data input device 110 can be connected and disconnected from the computer without opening the computer's enclosure. Once connected, the computer can then communicate with data input device 110. USB interfaces are supported by many modern operating systems such as Windows and Linux. USB interface 160 may also supply power to data input device 110.

The Universal Serial Bus is defined in the Universal Serial Bus Specification, revision 1.1 and Universal Serial Bus Specification, revision 2.0 which are hereby incorporated herein by reference. These documents are available from the USB Implementers Forum web page at www.usb.org.

In an embodiment, data input device 110 may be configured and controlled as a human input device. For example, data input device 110 may, as part of a USB enumeration process, inform a computer that it should be enumerated as, and thus treated as, a USB HID device class. The USB HID device class is described by the Device Class Definition for Human Interface Devices (HID). This document is available from the USB Implementers Forum web page at www.usb.org.

In an embodiment, data input device 110 may be configured and controlled as a mass storage device. For example, data input device 110 may, as part of a USB enumeration process, inform a computer that it should be enumerated as, and thus treated as, a USB Mass Storage Class (MSC) device. In another example, data input device 110 may inform a computer that it should be enumerated as a removable mass storage device such as a flash memory card.

The USB Mass Storage Class is specified by the Universal Serial Bus Mass Storage Class Specification. The Universal Serial Bus Mass Storage Class Specification is a collection of documents that include the Universal Serial Bus Mass Storage Class Specification Overview, Revision 1.2; Universal Serial Bus Mass Storage Class Bulk-Only Transport, Revision 1.0; Universal Serial Bus Mass Storage Class Control/Bulk/Interrupt (CBI) Transport, Revision 1.1; Universal Serial Bus Mass Storage Class UFI Command Specification, Revision 1.0; Universal Serial Bus Mass Storage Specification For Bootability, Revision 1.0; and, the Universal Serial Bus Lockable Storage Devices Feature Specification, Revision 1.0. These documents are available from the USB Implementers Forum web page at www.usb.org.

In an embodiment, as characters are typed on thumb sized keyboard 150, they are output on a USB interface 160 in real-time. Thus, a computer connected to USB interface 160 may receive the typed characters as if they were typed on a standard keyboard. The characters typed on thumb sized keyboard 150 may also be stored in a memory. This memory may be contained within data input device 110 (not shown). This memory may be contained within removable memory 125. When the characters typed on thumb sized keyboard 150 are stored in a memory, USB interface 160 may not be connected to a computer.

The characters stored in a memory may be sent to a computer via USB interface 160. For example, characters typed on thumb sized keyboard 150 may be stored on removable memory 125 by data input device 110 while USB interface 160 is not connected to a computer. Once data input device 110 is connected to a computer via USB interface 160, a user may command input device 110 to send those characters to the computer via USB interface 160. These characters may be received by the computer as if they were being typed in real-time on a keyboard attached to the computer. Thus, the characters typed and stored on removable memory 125 (or in internal memory) would be registered by, and appear on the computer's display screen, as if they were being typed by an attached keyboard into a currently open window, or application. In an embodiment, data input device 110 does not receive information regarding the appearance of typed characters in the currently open window, or application, back from the computer.

In an embodiment, data input device 110 may implement predictive text input methods. Predictive text (a.k.a., T9, iTap, SureType, auto completion, or word completion) allows some common words to be entered by a single or small number of key presses. In dictionary-based predictive text systems, as the user presses the buttons, the dictionary for a list of possible words that match the key press combination is searched. A candidate word (usually the most probable word) is offered up. The user can then confirm the selection and move on, or cycle through the possible combinations. A non-dictionary system constructs words and other sequences of letters from the statistics of word parts. It should be understood that English and non-English words, depending upon pre-programming of data input device 110, or a user selection, may be presented by data input device 110.

Because data input device 110 does not have a display, data input device 110 may offer up candidate words by sending them via USB interface 160. Then, as the user cycles through possible combinations, data input device may send appropriate editing keystrokes or character codes (e.g., backspace, delete, arrow keys) and the keystrokes for the candidate words to cause the possible combinations to be displayed.

A predictive text system used by data input device 110 may include a user database for storing entered words or phrases which are not well-disambiguated by a pre-supplied database. Words maybe entered into the user database without direct user intervention. This may be referred to as a “learning” system. Data input device 110 may further attempt to correct spelling, format text or perform other automatic rewrites, with the intent of enhancing the entry of text.

FIG. 1A is an illustration of the operation of a data input device. As can be seen in FIG. 1A, in an embodiment, the inputting surface of thumb-sized keyboard 150 is relatively small and adapted to be manipulated substantially with the thumbs. Thus, thumb-sized keyboard 150 is intended to be typed on using the available thumbs for inputting, while holding the device. However, other fingers, and other manipulation techniques (such a touch typing) may be used.

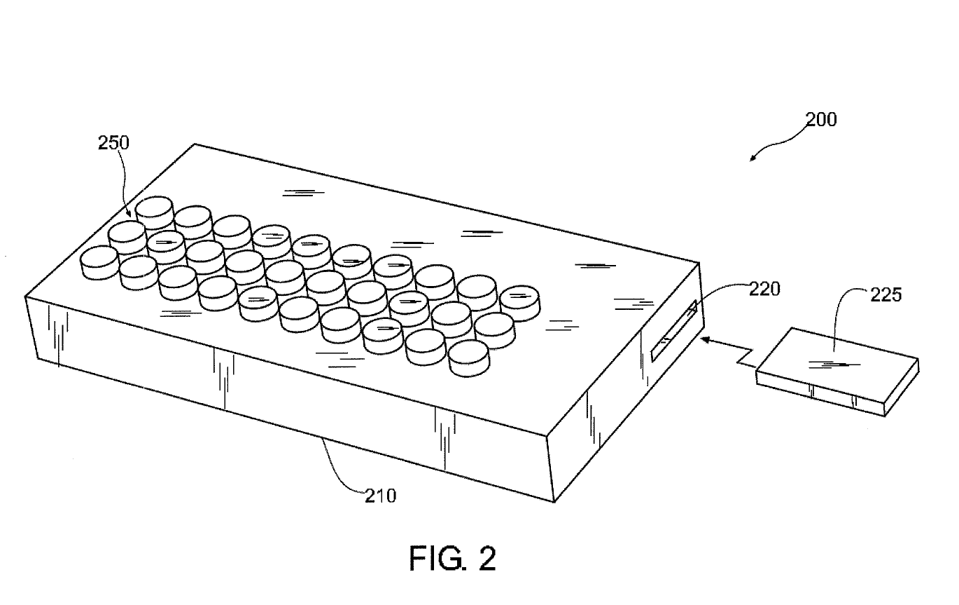

FIG. 2 is an illustration of a wireless data input device. In FIG. 2, data input system 200 comprises data input device 210 and removable memory 225. Data input device 210 includes removable memory interface 220 and thumb-sized keyboard 250. The inputting surface of thumb-sized keyboard 250 should be relatively small and adapted to be manipulated substantially with the thumbs. Thus, the keys of thumb-sized keyboard 250 should be sized and oriented to be pressed using the thumbs for inputting, while holding the device. However, other fingers, and other manipulation techniques (such a touch typing) may be used. Thumb-sized keyboard 250 may be a type of keyboard commonly found on PDAs, mobile phones, and PDA phones. Thumb-sized keyboard 250 may have a familiar layout to an ordinary keyboard. Thus, thumb-sized keyboard 250 may have at least one key for every letter of an alphabet. Thumb-sized keyboard 250 (like thumb-sized keyboard 150) may also be known as a mini-QWERTY keyboard. It should be understood, however, that thumb-sized keyboard 250 may have other key arrangements and dimensions. For example, thumb-sized keyboard 250 may follow the Dvorak key arrangement, or other key arrangements designed for non-English languages.

Removable memory 225 may comprise flash memory. Removable memory 225 may include one or more of the following types of flash memory devices: CompactFlash, SmartMedia, MultiMediaCard, Secure Digital, Memory Stick, xD, and USB flash drive. Removable memory 225 may include other types of non-volatile storage. Removable memory interface 220 provides electrical and physical connections between data input device 210 and removable memory 220. Removable memory interface 220 may interface with or more of CompactFlash, SmartMedia, MultiMediaCard, Secure Digital, Memory Stick, xD, and a USB flash drive. Removable memory interface 220 may interface with other types of non-volatile or volatile storage.

In an embodiment, data input device 210 communicates with a computer via a wireless link. This wireless link may be specified by one or more communication and/or wireless standards. For example, to facilitate wireless communications, the Institute of Electrical and Electronics Engineers (IEEE) has promulgated a number of wireless standards. These include the 802.11 (WiFi) standards, the 802.16 (WiMAX) standards, and the IEEE Standard 802.15 (Bluetooth) standards. Likewise, the International Telecommunication Union (ITU) has promulgated standards to facilitate wireless communications. This includes TIA-856, which is also known as Evolution-Data Optimized (EV-DO). The European Telecommunications Standards Institute (ETSI) has also promulgated a standard known as long term evolution (LTE). Additional standards such as the fourth generation communication system (4G) are also being pursued. The Wireless USB Promoter Group also advocates a wireless standard sometimes called Wireless USB. Wireless USB is sometimes abbreviated as “WUSB or “Certified Wireless USB”. Wireless USB is based on a common radio platform, which is capable of sending 480 Mbits/s at distances up to 3 meters. All of these standards may include specifications for various aspects of wireless communication. These aspects include processes for registering on the network, carrier modulation, frequency bands of operation, and message formats.

Accordingly, Wireless device 210 may be any device, system, combination of devices, or other such communication platform capable of communicating characters typed on thumb-sized keyboard 250 via a wireless link, either in real-time, or as stored in removable memory 225 as if they were being typed in real-time. Wireless device 210 may be, or comprise, for example, a mobile phone, a wireless phone, a wireless modem, a personal digital assistant (PDA), a voice over internet protocol (VoIP) phone, a voice over packet (VOP) phone, or a soft phone, as well as other types of devices or systems that can send typed characters via a wireless link or links in real-time, or as stored in removable memory 225, as if they were being typed in real-time. Other types of communication platforms are possible.

In an embodiment, as characters are typed on thumb sized keyboard 250, they are output on a wireless interface in real-time. Thus, a computer coupled to a receiver, or wireless network receiving these characters from data input device 210 may receive the typed characters as if they were typed on a standard keyboard. The characters typed on thumb sized keyboard 250 may also be stored in a memory. This memory may be contained within data input device 210 (not shown). This memory may be contained within removable memory 225. When the characters typed on thumb sized keyboard 250 are stored in a memory, data input device 210 may not actively coupled to a wireless receiver or network.

The characters stored in a memory may be sent to a computer via a wireless link or network. For example, characters typed on thumb sized keyboard 250 may be stored on removable memory 225 by data input device 210 while data input device 210 is not coupled via a wireless link to a wireless network or receiver. Once data input device 210 is coupled to a top a wireless receiver or network, a user may command data input device 210 to send those characters to the computer via a wireless link. These characters may be received and relayed to a computer. Once received by the computer, they may be received, registered, and/or displayed as if they were being typed in real-time on a keyboard attached to the computer. Thus, the characters typed and stored on removable memory 225 (or in internal memory) would be registered by, and appear on the computer's display screen, as if they were being typed by an attached keyboard into a currently open window, or application. In an embodiment, data input device 210 does not receive information regarding the appearance of the typed characters in the currently open window, or application, from the computer.

In an embodiment, data input device 210 may implement predictive text input methods. Because data input device 210 does not have a display, data input device 110 may offer up candidate words by sending them via a wireless interface in real-time. Then, as the user cycles through possible combinations, data input device may send appropriate editing keystrokes or character codes (e.g., backspace, delete, arrow keys) and the keystrokes for the candidate words to cause the possible combinations to be displayed. These candidate words may be from a selected or pre-programmed language (e.g., English, Japanese, Spanish, etc.) A predictive text system used by data input device 210 may include a user database for storing entered words or phrases which are not well-disambiguated by a pre-supplied database. Words maybe entered into the user database without direct user intervention. This may be referred to as a “learning” system. Data input device 210 may further attempt to correct spelling, format text or perform other automatic rewrites, with the intent of enhancing the entry of text.

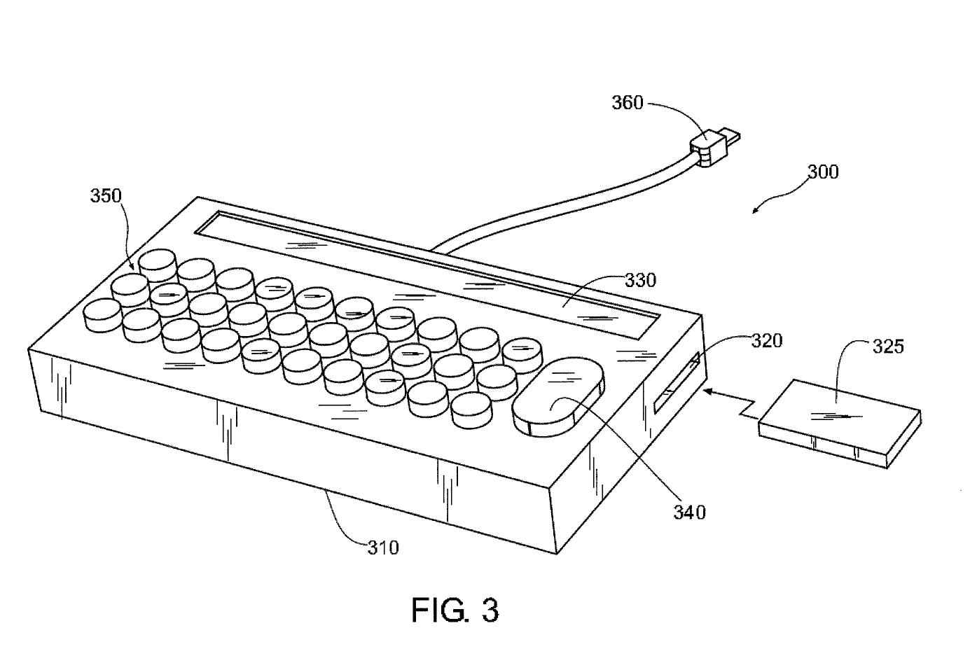

FIG. 3 is an illustration of a data input device with a display. In FIG. 3, data input system 300 comprises data input device 310 and removable memory 325. Data input device 310 includes removable memory interface 320, display 330, thumbstick 340, thumb-sized keyboard 350, and Universal Serial Bus USB interface 360.

The inputting surface of thumb-sized keyboard 350 should be relatively small and adapted to be manipulated substantially with the thumbs. Thus, the keys of thumb-sized keyboard 350 should be sized and oriented to be pressed using the thumbs for inputting, while holding the device. However, other fingers, and other manipulation techniques (such a touch typing) may be used. Thumb-sized keyboard 350 may be a type of keyboard commonly found on PDAs, mobile phones, and PDA phones. Thumb-sized keyboard 350 may have a familiar layout to an ordinary keyboard. Thus, thumb-sized keyboard 350 may have at least one key for every letter of an alphabet. Thumb-sized keyboard 350 (like thumb-sized keyboard 150 or 250) may also be known as a mini-QWERTY keyboard. It should be understood, however, that thumb-sized keyboard 350 may have other key arrangements and dimensions. For example, thumb-sized keyboard 350 may follow the Dvorak key arrangement, or other key arrangements designed for non-English languages.

Removable memory interface 320 provides electrical connections between data input device 210 and removable memory 325. Removable memory interface 320 may interface with or more of CompactFlash, SmartMedia, MultiMediaCard, Secure Digital, Memory Stick, xD, and a USB flash drive. Removable memory interface 320 may interface with other types of non-volatile storage.

Thumbstick 340 (a.k.a. a control stick) may be an input device for a controller that is used for two-dimensional input. Thumbstick 340 may consist of some sort of protrusion, and the input is based on the position of this protrusion, or the depression of a side or sides of the protrusion (or key). In another embodiment, thumbstick 340 may be a directional pad (a.k.a., directional pad; also further known as a joypad). A D-pad is a flat, usually thumb-operated directional control often found on video game console gamepads, game controllers and on the remote control units of some television and DVD players and smart phones. Typically, a D-pad has one button on each point. Like video game joysticks, D-pads are typically digital. In other words, only the directions provided on the D-pad buttons can be used, with no intermediate values. However, combinations of two directions (up and left, for example) do provide diagonals and D-pads may be used to provide eight-directional input if appropriate.

For data input device 310 to communicate with a computer, it may be connected to a computer. Typically, this is done by plugging USB interface 360 into a port built into the computer. Like other plug-in devices, data input device 310 can be connected and disconnected from the computer without opening the computer's enclosure. Once connected, the computer can then communicate with data input device 310. USB interface 360 may also supply power to data input device 310.

In an embodiment, as characters are typed on thumb sized keyboard 350, they are displayed on display 330. The characters typed on thumb sized keyboard 350 may also be output on a USB interface 360 in real-time. In addition, thumbstick 340 may be used to control a cursor on display 330 or on a computer in real-time. Thus, a computer connected to USB interface 360 may receive the typed characters as if they were typed on a standard keyboard. Likewise, a computer connected to USB interface 360 may move a cursor in response to thumbstick 340 as if it were being manipulated by a mouse connected to the computer. In an embodiment, data input device 310 does not receive information regarding the appearance of the typed characters, in the currently open window, or application, or receive information regarding the motion of the cursor in response to the manipulations of the thumbstick, from the computer.

The characters typed on thumb sized keyboard 350 may also be stored in a memory. This memory may be contained within data input device 310 (not shown). This memory may be contained within removable memory 325. When the characters typed on thumb-sized keyboard 350 are stored in a memory, USB interface 360 may not be connected to a computer.

The characters stored in a memory, and the manipulations of thumbstick 340 may be sent to a computer via USB interface 360. For example, characters typed on thumb sized keyboard 350 may be stored on removable memory 325 by data input device 310 while USB interface 360 is not connected to a computer. Once data input device 310 is connected to a computer via USB interface 360, a user may manipulate thumbstick 340 to select a program or Graphical User Interface (GUI) interface window. The user may then command data input device 310 to send those characters to the computer via USB interface 360. These characters may be received by the program or GUI interface window as if they were being typed in real-time on a keyboard attached to the computer. Thus, the characters typed and stored on removable memory 325 (or in internal memory) would be registered by, and appear on the computer's display screen, as if they were being typed by an attached keyboard into the selected window, or application. In an embodiment, data input device 310 does not receive information regarding the appearance of the sent characters, in the currently open window, or application, from the computer.

In an embodiment, data input device 310 may implement predictive text input methods. As key presses are made on keyboard 350, data input device 310 may offer up candidate words on display 330. The user may then cycle through possible combinations. When the user indicates a desired candidate word, data input device 310 may send the entirety of that word via USB interface 360, or store that word in removable memory 325. The candidate words may be from a selected or pre-programmed language (e.g., English, Japanese, Spanish, etc.) The candidate words may be retrieved from removable memory device 325. A predictive text system used by data input device 310 may include a user database for storing entered words or phrases which are not well-disambiguated by a pre-supplied database. Words maybe entered into the user database without direct user intervention. This may be referred to as a “learning” system. Data input device 310 may further attempt to correct spelling, format text or perform other automatic rewrites, with the intent of enhancing the entry of text.

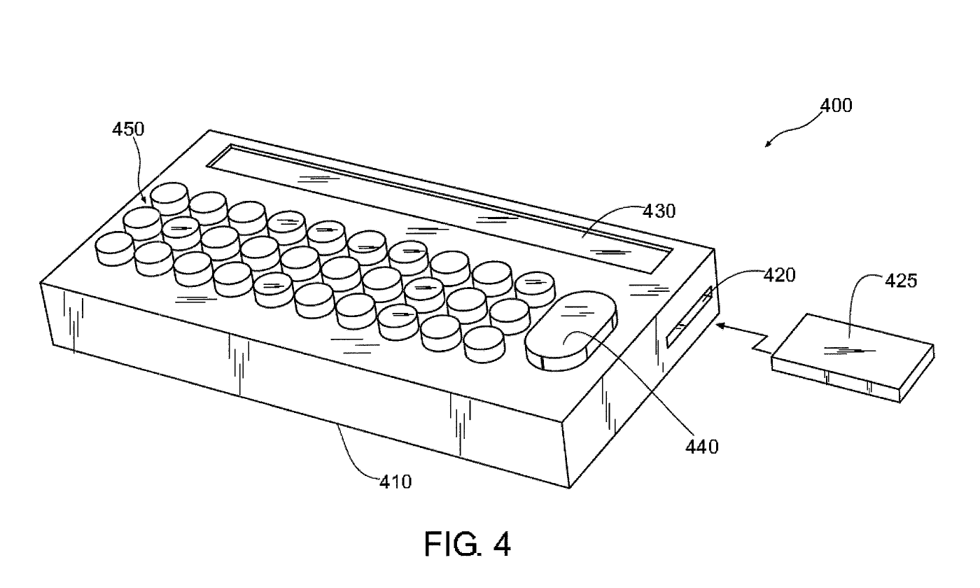

FIG. 4 is an illustration of a wireless data input device with a display. In FIG. 4, data input system 400 comprises data input device 410 and removable memory 425. Data input device 410 includes removable memory interface 420, display 430, thumbstick 440, and thumb-sized keyboard 450.

The inputting surface of thumb-sized keyboard 450 should be relatively small and adapted to be manipulated substantially with the thumbs. Thus, the keys of thumb-sized keyboard 450 should be sized and oriented to be pressed using the thumbs for inputting, while holding the device. However, other fingers, and other manipulation techniques (such a touch typing) may be used. Thumb-sized keyboard 450 may be a type of keyboard commonly found on PDAs, mobile phones, and PDA phones. Thumb-sized keyboard 450 may have a familiar layout to an ordinary keyboard. Thus, thumb-sized keyboard 450 may have at least one key for every letter of an alphabet. Thumb-sized keyboard 450 may also be known as a mini-QWERTY keyboard. It should be understood, however, that thumb-sized keyboard 450 may have other key arrangements and dimensions. For example, thumb-sized keyboard 450 may follow the Dvorak key arrangement, or other key arrangements designed for non-English languages.

Removable memory 425 may comprise flash memory. Removable memory 425 may include one or more of the following types of flash memory devices: CompactFlash, SmartMedia, MultiMediaCard, Secure Digital, Memory Stick, xD, and USB flash drive. Removable memory 425 may include other types of non-volatile storage. Removable memory interface 420 provides electrical and physical connections between data input device 410 and removable memory 420. Removable memory interface 420 may interface with or more of CompactFlash, SmartMedia, MultiMediaCard, Secure Digital, Memory Stick, xD, and a USB flash drive. Removable memory interface 420 may interface with other types of non-volatile or volatile storage.

Thumbstick 440 may be an input device for a controller that is used for two-dimensional input. Thumbstick 440 may consist of some sort of protrusion, and the input is based on the position of this protrusion, or the depression of a side or sides of the protrusion (or key). In another embodiment, thumbstick 440 may be a directional pad (a.k.a., directional pad; also further known as a joypad). A D-pad is a flat, usually thumb-operated directional control often found on video game console gamepads, game controllers and on the remote control units of some television and DVD players and smart phones. Typically, a D-pad has one button on each point. Like video game joysticks, D-pads are digital typically digital. In other words, only the directions provided on the D-pad buttons can be used, with no intermediate values. However, combinations of two directions (up and left, for example) do provide diagonals and D-pads may be used to provide eight-directional input if appropriate.

In an embodiment, data input device 410 communicates with a computer via a wireless link. This wireless link may be specified by one or more communication and/or wireless standards. For example, to facilitate wireless communications, the Institute of Electrical and Electronics Engineers (IEEE) has promulgated a number of wireless standards. These include the 802.11 (WiFi) standards, the 802.16 (WiMAX) standards, and the IEEE Standard 802.15 (Bluetooth) standards. Likewise, the International Telecommunication Union (ITU) has promulgated standards to facilitate wireless communications. This includes TIA-856, which is also known as Evolution-Data Optimized (EV-DO). The European Telecommunications Standards Institute (ETSI) has also promulgated a standard known as long term evolution (LTE). Additional standards such as the fourth generation communication system (4G) are also being pursued. The Wireless USB Promoter Group also advocates a wireless standard sometimes called Wireless USB. Wireless USB is sometimes abbreviated as “WUSB or “Certified Wireless USB”. Wireless USB is based on a common radio platform, which is capable of sending 480 Mbits/s at distances up to 3 meters. All of these standards may include specifications for various aspects of wireless communication. These aspects include processes for registering on the network, carrier modulation, frequency bands of operation, and message formats.

Accordingly, wireless device 410 may be any device, system, combination of devices, or other such communication platform capable of communicating characters typed on thumb-sized keyboard 450 via a wireless link, either in real-time, or as stored in removable memory 425 as if they were being typed in real-time. Wireless device 410 may be, or comprise, for example, a mobile phone, a wireless phone, a wireless modem, a personal digital assistant, a VoIP phone, a VOP phone, or a soft phone, as well as other types of devices or systems that can send typed characters and thumbstick manipulations via a wireless link or links in real-time. Other types of communication platforms are possible.

In an embodiment, as characters are typed on thumb sized keyboard 450, they are output on a wireless interface in real-time. Thus, a computer coupled to a receiver, or wireless network receiving these characters from data input device 410 may receive the typed characters as if they were typed on a standard keyboard. Likewise, the manipulations of thumbstick 440 (or representations thereof) may be output on the wireless interface in real-time. Thus, a computer coupled to the receiver, or the wireless network receiving these manipulations from data input device 410 may receive the manipulations characters as if they were being made to a pointing device (e.g., a mouse) directly connected to the computer. In an embodiment, data input device 410 does not receive information regarding the appearance of the typed characters, in the currently open window, or application, or receive information regarding the motion of the cursor in response to the manipulations of the thumbstick, from the computer.

The characters typed on thumb sized keyboard 450 may also be stored in a memory. This memory may be contained within data input device 410 (not shown). This memory may be contained within removable memory 425. When the characters typed on thumb sized keyboard 450 are stored in a memory, data input device 410 may not actively coupled to a wireless receiver or network.

The characters stored in a memory may be sent to a computer via a wireless link or network. For example, characters typed on thumb sized keyboard 450 may be stored on removable memory 425 by data input device 410 while data input device 410 is not coupled via a wireless link to a wireless network or receiver. Once data input device 410 is coupled to a wireless receiver or network, a user may use thumbstick 440 to select a program or GUI interface window. The user may then command data input device 410 to send characters stored in the memory to the computer via the wireless network. The characters may be received by the program or GUI interface window as if they were being typed in real-time on a keyboard attached to the computer. Thus, the characters typed and stored on removable memory 425 (or in internal memory) would be registered by, and appear on the computer's display screen, as if they were being typed by an attached keyboard into the selected window, or application. In an embodiment, data input device 410 does not receive information regarding the appearance of the sent characters, in the currently open window, or application, from the computer.

In an embodiment, data input device 410 may implement predictive text input methods. As key presses are made on keyboard 450, data input device 410 may offer up candidate words on display 430. The user may then cycle through possible combinations. When the user indicates a desired candidate word, data input device 410 may send the entirety of that word via a wireless interface, or store that word in removable memory 425. The candidate words may be from a selected or pre-programmed language (e.g., English, Japanese, Spanish, etc.) The candidate words may be retrieved from removable memory device 425. A predictive text system used by data input device 410 may include a user database for storing entered words or phrases which are not well-disambiguated by a pre-supplied database. Words maybe entered into the user database without direct user intervention. This may be referred to as a “learning” system. Data input device 410 may further attempt to correct spelling, format text or perform other automatic rewrites, with the intent of enhancing the entry of text.

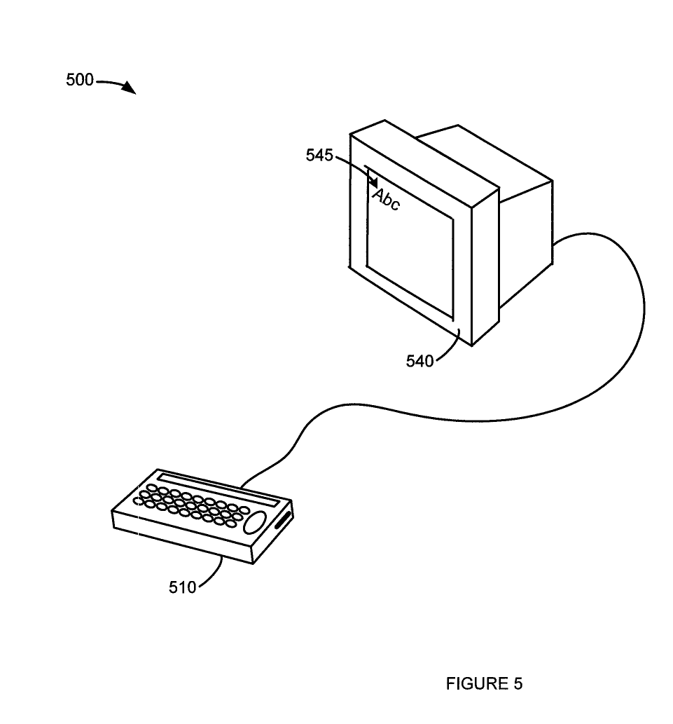

FIG. 5 is a block diagram illustrating a data input system. In FIG. 5, data input system 500 comprises data input device 510 and display 540. Data input device 510 is operatively coupled to display 540.

In an embodiment, data input device 510 is operatively coupled to display 540 via wired interface. For example, data input device 510 may be operatively coupled to display 540 via a graphics adapter port. Examples of graphics adapter ports that data input device 510 may have include video graphics array (VGA), Digital Visual Interface (DVI), Video In Video Out (VIVO), S-video, composite video, component video, and High-Definition Multimedia Interface (HDMI).

Data input device 510 may be or comprise a data input device described previously. Thus, characters 545 typed on data input device 510, or stored in a memory on data input device 510, or offered as predictive text, may be displayed on display 540.

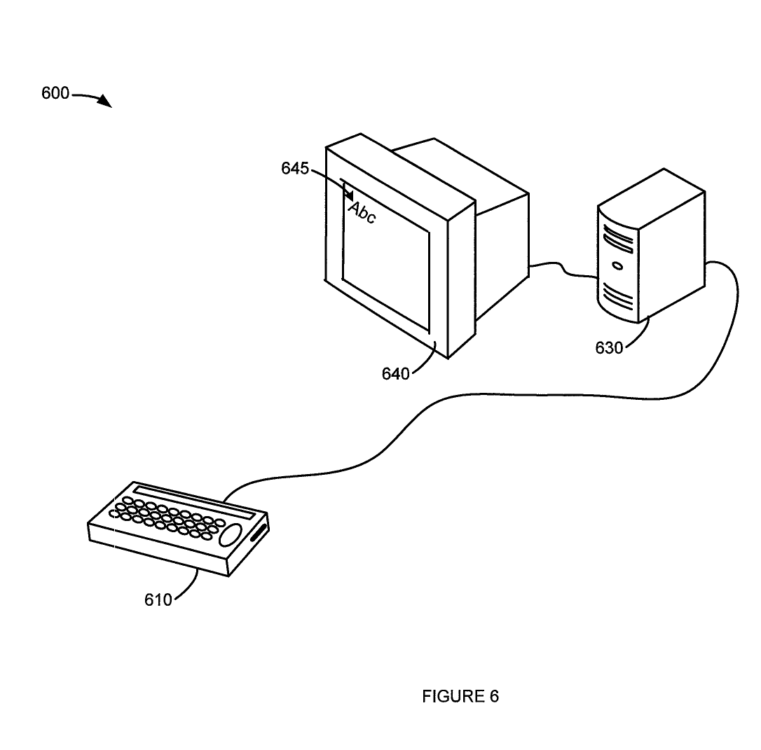

FIG. 6 is a block diagram illustrating a data input system. In FIG. 6, data input system 600 comprises data input device 610, computer 630, and display 640. Data input device 610 is operatively coupled to computer 630. Computer 630 is operatively coupled to display 640. Data input device 610 may be or comprise data input device described previously. Thus, characters 645 typed on data input device 610, or stored in a memory on data input device 610, or offered as predictive text, may be received by computer 630 and displayed on display 640. These characters 645 may be received, registered, and displayed by computer 630 in real-time. These characters 645 may be received, registered, and displayed by computer 630 in real-time as they are typed. These characters 645 may be received, registered, and displayed by computer 630 as if they are being typed even though they are coming from a memory coupled with data input device 610.

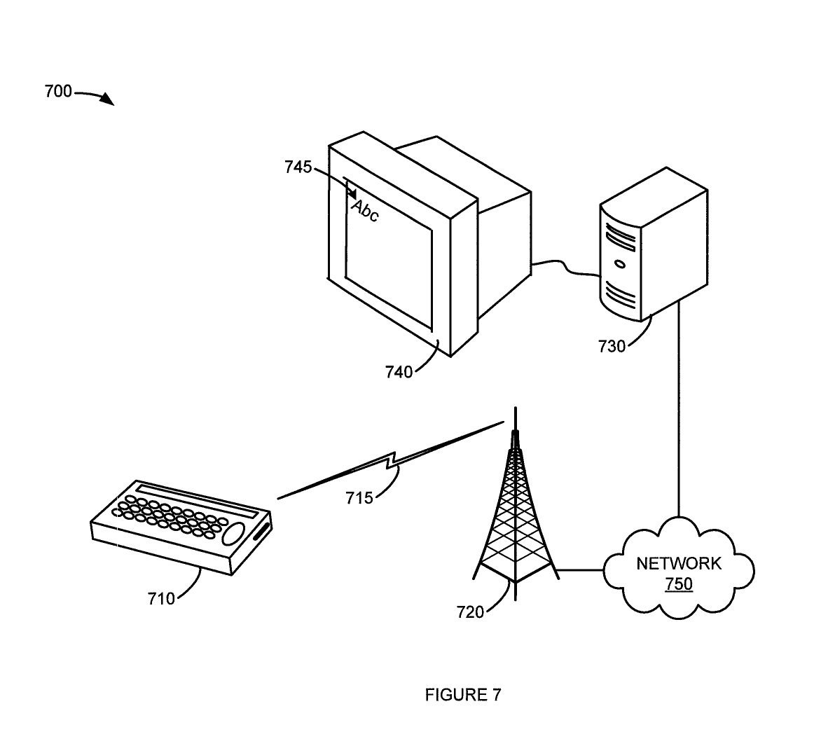

FIG. 7 is a block diagram illustrating a wireless data input system. In FIG. 7, data input system 700 comprises data input device 710, wireless link 715, wireless access point 720, network 750, computer 730, and display 640. Data input device 710 is operatively coupled to wireless access point 720 via wireless link 715. Wireless access point 720 is operatively coupled to network 750. Network 750 is operatively coupled to computer 730. Computer 730 is operatively coupled to display 740.

Data input device 710 may be or comprise a data input device described previously. Thus, characters 745 typed on data input device 710, or stored in a memory on data input device 710, or offered as predictive text, may be received by computer 730 via wireless link 715, wireless access point 720, and network 750 and displayed on display 740. These characters 745 may be received, registered, and displayed by computer 730 in real-time. These characters 745 may be received, registered, and displayed by computer 730 in real-time as they are typed. These characters 745 may be received, registered, and displayed by computer 730 as if they are being typed even though they are coming from a memory coupled with data input device 710.

Wireless access point 720 may provide a wireless connectivity service from data input device 710, via wireless link 715, to network 750. For example, wireless access point 720 may provide a wireless service based on a wireless communication standard. Examples of these wireless services include, but are not limited to, WiFi, WiMAX, Bluetooth, EV-DO, LTE, 3G, 4G, GSM, CDMA, TDMA, wireless USB, and the like. Other types of wireless service(s) may be provided by wireless access point 720.

Wireless access points that may be utilized include, base transceiver stations (BTSs), radio base stations (RBSs), Node B, enhanced Node B (eNBs), hotspots, 802.11 access points, wireless routers, and others. Wireless access points may include a number of elements known to those skilled in the art comprising a transceiver, power amplifier, combiner, duplexer, antenna and control function.

Network 750 may comprise a computer, a network, or a collection of computers and networks that couple, link, or otherwise operatively provide wireless access point 720 with communication service to computer 730. It should be understood that network 750 may comprise directly connected links (e.g., USB or Firewire links). It should also be understood that network 750 may comprise secondary data networks. For example, network 750 may include a backhaul network, a local network, a long distance network, a packet network, the Internet, a wireless network, or any combination thereof, as well as other types of networks. Network 750 may be or include an access service network (ASN), an access service network gateway (ASN-GW), wireless local access network access gateway (WAG), packet data gateway (PDG), mobile switching center (MSC), packet data serving node (PDSN), wireless access point, wireless USB link, router, or switch.

In an embodiment, the keyboard and mouse events from data input device 710 may be communicated via wireless link 715 and network 750 to computer 730 using the Remote FrameBuffer (RFB) protocol. The RFB protocol is defined in the RFB Protocol specification, version 3.8 (and previous versions) is hereby incorporated herein by reference. These documents are available from formed RealVNC, Ltd. at www.realvnc.com. In an embodiment, the keyboard and mouse events from data input device 710 may be communicated via wireless link 715 and network 750 to computer 730 using a different protocol. This protocol may, for example, not include messages for updating data input device 710 with changes to the display 740. In another example, this protocol may not include (or just not send) messages for updating data input device 710 with changes to the display 740 as a result of displaying typed characters 745 and cursor movements.

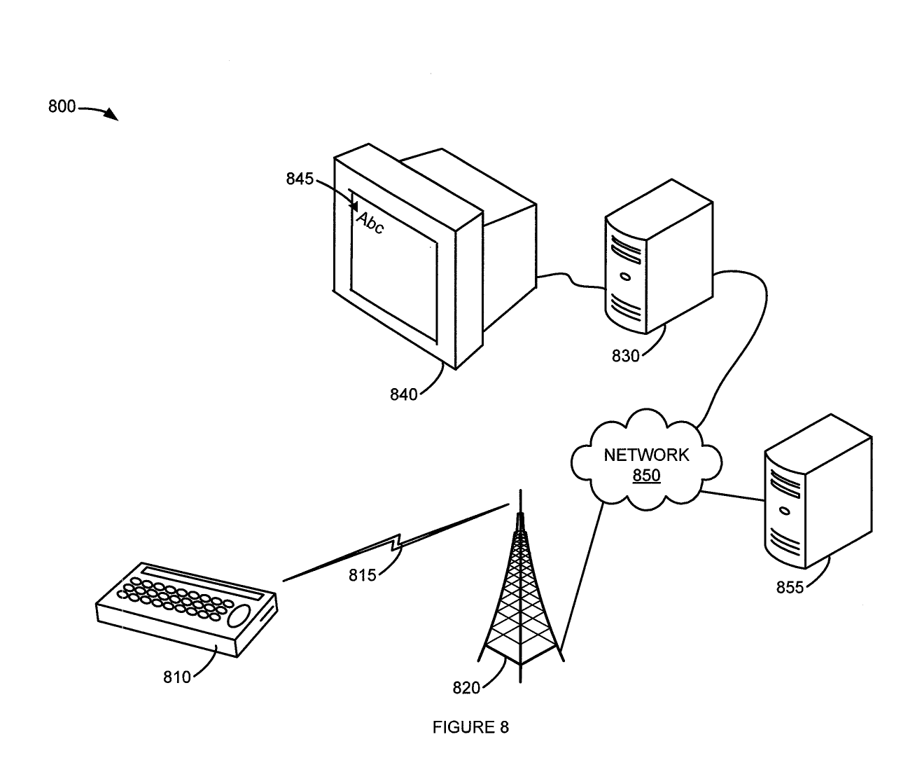

FIG. 8 is a block diagram illustrating a wireless data input system. In FIG. 8, data input system 800 comprises data input device 810, wireless link 815, wireless access point 820, network 850, computer 830, computer 855, and display 840. Data input device 810 is operatively coupled to wireless access point 820 via wireless link 815. Wireless access point 820 is operatively coupled to network 850. Network 850 is operatively coupled to computer 855. Network 850 is operatively coupled to computer 830. Computer 830 is operatively coupled to display 840.

Data input device 810 may be or comprise a data input device described previously. Thus, characters 845 typed on data input device 810, or stored in a memory on data input device 810, or offered as predictive text, may be received by computer 830 via a path comprising wireless link 815, wireless access point 820, network 850, and computer 855. After receiving characters 845, computer 830 may display characters 845 on display 840. These characters 845 may be received, registered, and displayed by computer 830 in real-time. These characters 845 may be received, registered, and displayed by computer 830 in real-time as they are typed. These characters 845 may be received, registered, and displayed by computer 830 as if they are being typed even though they are coming from a memory coupled with data input device 810.

In an embodiment, data input device 810 may direct characters typed on data input device 810 to computer 855 via network 850. Computer 855 may process these characters and then forward them in real-time to computer 830 via network 850. In an embodiment, the typed characters may be embedded in a non-real time protocol for delivery to computer 855 and/or computer 830. For example, the typed characters may be placed in a Simple Messaging Service (SMS) text message for delivery to computer 855 and/or computer 830. In another example, the typed characters may be placed in a real-time protocol (RTP) packet or Hypertext Transport Protocol (HTTP) packet for delivery to computer 855 and/or computer 830.

When computer 855 receives the typed characters, and/or thumbstick manipulations, computer 855 may process these before forwarding to computer 830 for display on display 840. In an embodiment, computer 855 may receive the characters via one format (or protocol) and send them using a different protocol. For example, computer 855 may receive an SMS message from data input device 810. Computer 855 may then process this SMS message to extract the typed characters and then send them in real-time using a different protocol to computer 830 for display on display 840.

In another embodiment, computer 855 may act as a relay station or facilitator for routing messages between data input device 810 and computer 830. For example, data input device 810 may send the typed characters to computer 855 for relay to computer 830 without knowing the address (e.g., IP address) of computer 830. Computer 855 would then be responsible for determining how to send the typed characters to computer 830. In this manner, data input device 810 does not need to know of the location or other networking information (e.g., IP address) of computer 830 in order to send the typed characters to computer 830. Computer 855 is responsible for coupling data input device 810 and computer 830.

Computer 855 may couple data input device 810 and computer 830 by maintaining an association between data input device 810 and computer 830. This association may allow computer 855 to receive the characters typed on data input device 810 and route/redirect them (with or without intermediate processing) to computer 830 in real-time. This association may be based on one or more device identifiers associated with data input device 810 and/or computer 830. A device identifier may be one or more, but is not limited to, a mobile phone number, a mobile directory number (MDN), mobile identification number (MIN), electronic serial number (ESN), medium access control address (MAC address), or internet protocol address (IP address). Other types of device identifiers are also possible. In another embodiment, computer 855 may provide authentication and authorization for data input device 810 to send, and/or computer 830 to receive, the typed characters (and thumbstick manipulations).

Wireless access point 820 may provide a wireless connectivity service from data input device 810, via wireless link 815, to network 850. For example, wireless access point 820 may provide a wireless service based on a wireless communication standard. Examples of these wireless services include, but are not limited to, WiFi, WiMAX, Bluetooth, EV-DO, LTE, 3G, 4G, GSM, CDMA, TDMA, wireless USB, and the like. Other types of wireless service(s) may be provided by wireless access point 820.

Wireless access points that may be utilized include, BTSs, radio base stations (RBSs), Node B, eNBs, hotspots, 802.11 access points, wireless routers, and others. Wireless access points may include a number of elements known to those skilled in the art comprising a transceiver, power amplifier, combiner, duplexer, antenna and control function.

Network 850 may comprise a computer, a network, or a collection of computers and networks that couple, link, or otherwise operatively provide wireless access point 820, computer 830, and computer 855 with communication service to each other. It should be understood that network 850 may comprise directly connected links. It should also be understood that network 850 may comprise secondary data networks. For example, network 850 may include a backhaul network, a local network, a long distance network, a packet network, the Internet, a wireless network, or any combination thereof, as well as other types of networks. Network 850 may be or include an ASN, an ASN-GW, WAG, PDG, MSC, PDSN, wireless access point, wireless USB link, router, or switch.

In an embodiment, the keyboard and mouse events from data input device 810 may be communicated through network 850 using RFB protocol. In an embodiment, the keyboard and mouse events from data input device 810 may be communicated using a different protocol. This protocol may, for example, not include messages for updating data input device 810 with changes to the display 840. In another example, this protocol may not include (or not send) messages for updating data input device 810 with changes to the display 840 as a result of displaying typed characters 845 and cursor movements.

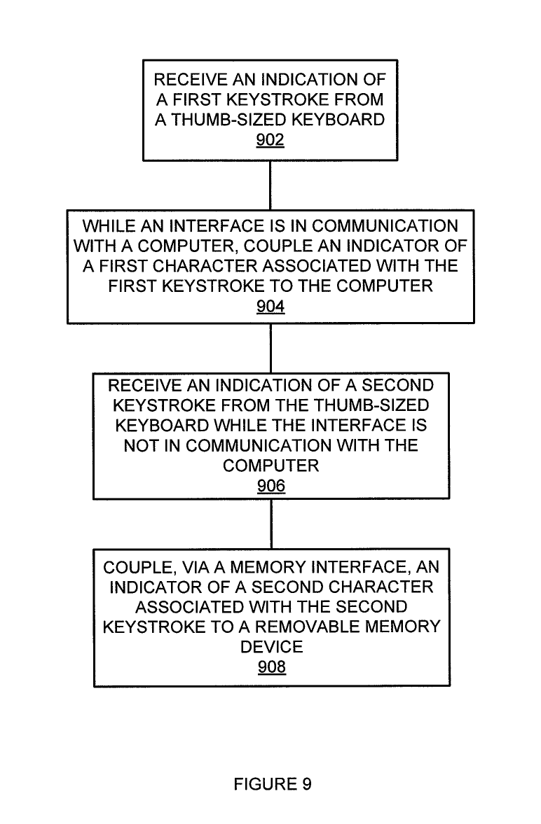

FIG. 9 is a flowchart illustrating a method of providing input to a computer. The steps illustrated in FIG. 9 may be performed by one or more elements of data input systems 100-800.

An indication of a first keystroke is received from a thumb-sized keyboard (902). For example, data input device 110 may receive an indicator of a keystroke on thumb sized keyboard 150 while USB interface 160 interface is connected to a computer. An indicator of a first character associated with a first keystroke is coupled to the computer (904). For example, data input device 110 may couple an indicator of the character associated with the first keystroke to a computer via USB interface 160 while USB interface 160 is in communication with the computer. In another example, data input device 610 may couple an indicator of the character associated with a keystroke to computer 630 while data input device 610 is operatively coupled computer 630.

An indication of a second keystroke from the thumb sized keyboard is received while the interface is not in communication with the computer (906). For example, data input device 110 may receive an indicator of a keystroke on thumb sized keyboard 150 while USB interface 160 is not connected. Via a memory interface, an indicator of a second character associated with a second keystroke is coupled to a removable memory device (908). For example, data input device 110 may couple an indicator of the second character to removable memory 125 via removable memory interface 120.

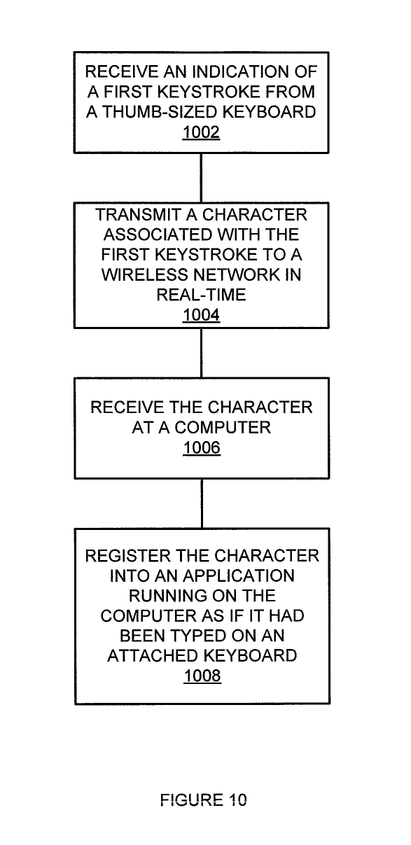

FIG. 10 is a flowchart illustrating a method of providing real-time input to a computer. The steps illustrated in FIG. 10 may be performed by one or more elements of data input systems 100-800.

An indication of a first keystroke is received from a thumb sized keyboard (1002). For example, data input device 210 may receive an indication of a first keystroke from a thumb sized keyboard 250. In another example, data input device 710 may receive an indication of a first keystroke on its thumb sized keyboard. The character associated with a first keystroke is transmitted in real-time to a wireless network (1004). For example, data input device 210 may transmit a character associated with a first keystroke to a wireless network in real-time. In another example, data input device 710 may transmit a character associated with a first keystroke to a wireless network via wireless link 715.

The character is received at a computer (1006). For example, the character sent by data input device 210 may be received at a computer. In another example, the character sent by data input device 710 may be received by computer 730 after being sent via wireless link 715 and network 750. The character is registered in an application running on the computer as if it had been typed on an attached keyboard (1008). For example, computer 730 may register, and display on display 740, the character send by data input device 710 as if the character had been typed on a keyboard attached to computer 730.

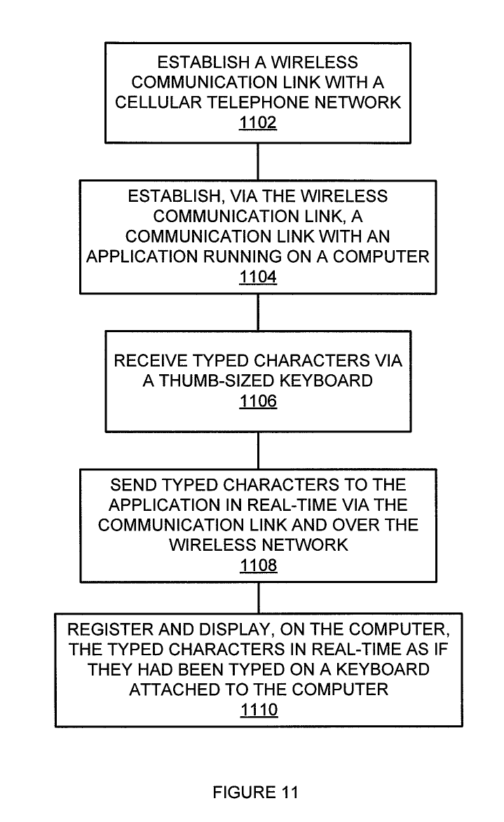

FIG. 11 is a flowchart illustrating a method of providing real-time input to a computer via a cellular telephone network. The steps illustrated in FIG. 11 may be performed by one or more elements of data input systems 100-800.

A wireless communication link is established with a cellular telephone network (1102). For example, data input device 810 may establish wireless communication link 815 with wireless access point 820. Wireless access point 820 may be a cellular telephone network access point. Via the wireless communication link, he communication link is established an application running on a computer (1104). For example, data input device 810 may establish a communication link with an application running on computer 830. This communication link may be established via wireless communication link 815, wireless access point 820, and network 850.

Characters typed via a thumb sized keyboard are received (1106). For example, data input device 810 may receive characters typed on its thumb sized keyboard. In another example, computer 855 may receive characters typed on data input device 810. Typed characters are sent to the application in real-time via the communication link and over the wireless network (1108). For example, data input device 810 may send characters typed on its keyboard in real-time to an application running on computer 830. These characters would be sent to computer 830 via network 850. In another example, computer 855 may send characters it received from data input device 810 to computer 830 via network 850.

The typed characters are registered and displayed on the computer in real-time as if they had been typed on a keyboard attached to the computer (1110). For example, computer 830 may register and display the characters it received from data input device 810 were computer 855 as if they had been typed on a keyboard attached to computer 830.

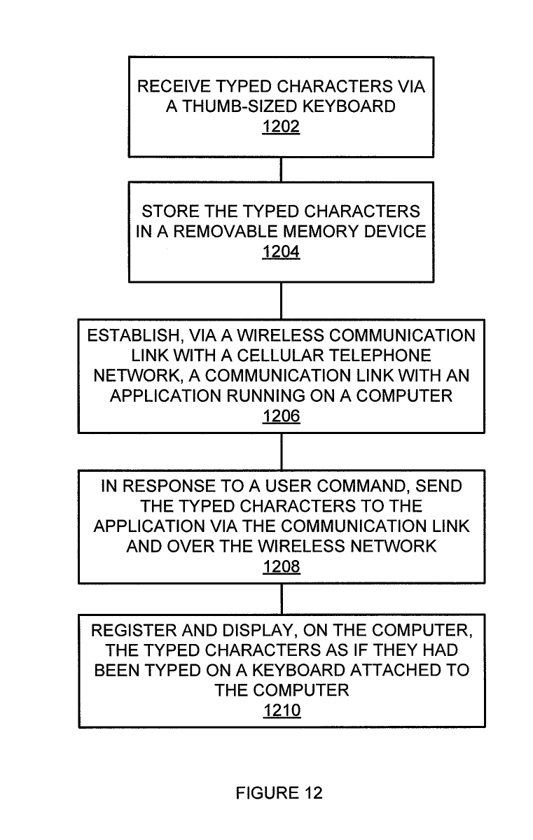

FIG. 12 is a flowchart illustrating a method of providing stored input to a computer. The steps illustrated in FIG. 12 may be performed by one or more elements of data input systems 100-800.

Characters typed via a thumb sized keyboard are received (1202). For example, data input device 810 may receive characters typed on its keyboard. The typed characters are stored in a removable memory device (1204). For example, data input device 810 may store characters typed on its keyboard in a removable memory device. In another example data input device 410 may store characters typed on its keyboard into a removable memory device 425.

Via a wireless communication link with a cellular telephone network, a communication link is established within application running on a computer (1206). For example, data input device 810 may establish a communication link with an application running on computer 830 via network 850 and wireless access point 820. In response to a user command, the typed characters are sent to the application via the communication link and over the wireless network (1208). For example, in response to a user command or keystroke on data input device 810, data input device 810 may send the typed characters that are stored on a removable memory device to computer 830 via wireless access point 820 and network 850.

The typed characters are registered and displayed on the computer as if they had been typed on a keyboard attached to the computer (1210). For example, computer 830 may register and display the characters it received from data input device 810 were computer 855 as if they had been typed on a keyboard attached to computer 830.

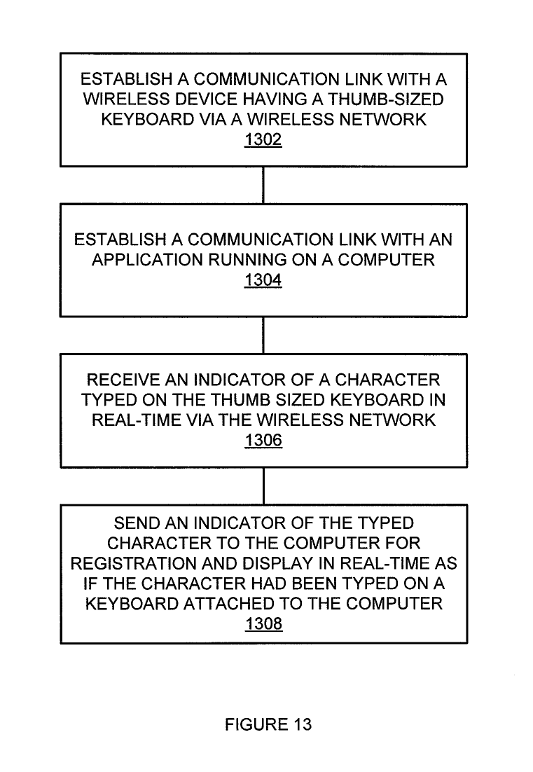

FIG. 13 is a flowchart illustrating a method of providing a real-time input service. The steps illustrated in FIG. 13 may be performed by one or more elements of data input systems 100-800.

Via a wireless network, a communication link is established with a wireless device having a thumb sized keyboard (1302). For example, computer 855 may establish a communication link with data input device 810 via network 850, wireless access point 820, and wireless link 815. A communication link is established within application running on a computer (1304). For example, computer 855 may establish a communication link with an application running on the computer 830.

An indicator of the characters typed on the thumb sized keyboard is received in real-time, via the wireless network (1306). For example, an indicator of a character typed on data input device 810 may be received by computer 855 via wireless link 815 and network 850. An indicator of the typed character is a sent to the computer for registration and display, in real-time, as if the character had been typed on a keyboard attached to the computer (1308). For example, computer 855 may send an indicator of the character to computer 830 for registration and display in real-time as if the character had been typed on a keyboard attached to computer 830.

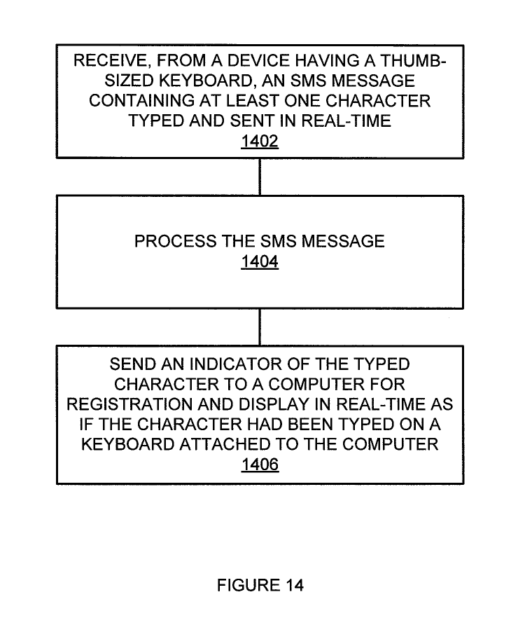

FIG. 14 is a flowchart illustrating a method of providing input to a computer using simple messaging service (SMS) protocol. The steps illustrated in FIG. 14 may be performed by one or more elements of data input systems 100-800.

From a device having a thumb sized keyboard and SMS message containing at least one character typed and sent in real-time is received (1402). For example, computer 855 may receive an SMS message from data input device 810. This message, which contains at least one character, may be sent by data input device 810 in real-time. The SMS message is processed (1404). For example, computer 855 may process the received SMS message. The SMS message may be processed to extract the typed character from the SMS message. In another example, the SMS message may be processed to convert it to another protocol (such as RFB protocol).

An indicator of the typed character is sent to a computer for registration and display in real-time as if the character had been typed on a keyboard attached to the computer (1406). For example, computer 855 may send a message indicating the typed character to computer 830 for registration and display, in real-time, as if the character had been typed on a keyboard attached to computer 830.

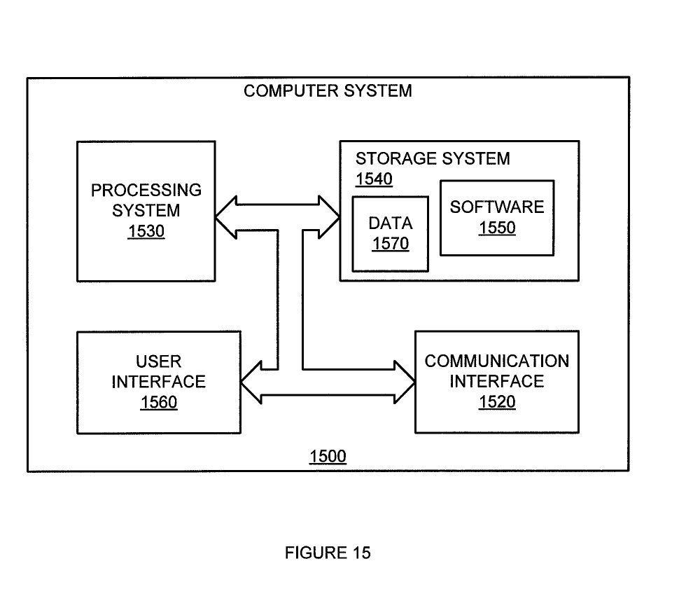

FIG. 15 illustrates a block diagram of a computer system. Computer system 1500 includes communication interface 1520, processing system 1530, storage system 1540, and user interface 1560. Processing system 1530 is operatively coupled to storage system 1540. Storage system 1540 stores software 1550 and data 1570. Processing system 1530 is operatively coupled to communication interface 1520 and user interface 1560. Computer system 1500 may comprise a programmed general-purpose computer. Computer system 1500 may include a microprocessor. Computer system 1500 may comprise programmable or special purpose circuitry. Computer system 1500 may be distributed among multiple devices, processors, storage, and/or interfaces that together comprise elements 1520-1570.

Communication interface 1520 may comprise a network interface, modem, port, bus, link, transceiver, or other communication device. Communication interface 1520 may be distributed among multiple communication devices. Processing system 1530 may comprise a microprocessor, microcontroller, logic circuit, or other processing device. Processing system 1530 may be distributed among multiple processing devices. User interface 1560 may comprise a keyboard, mouse, voice recognition interface, microphone and speakers, graphical display, touch screen, or other type of user interface device. User interface 1560 may be distributed among multiple interface devices. Storage system 1540 may comprise a disk, tape, integrated circuit, RAM, ROM, network storage, server, or other memory function. Storage system 1540 may be a computer readable medium. Storage system 1540 may be distributed among multiple memory devices.

Processing system 1530 retrieves and executes software 1550 from storage system 1540. Processing system may retrieve and store data 1570. Processing system may also retrieve and store data via communication interface 1520. Processing system 1550 may create or modify software 1550 or data 1570 to achieve a tangible result. Processing system may control communication interface 1520 or user interface 1570 to achieve a tangible result. Processing system may retrieve and execute remotely stored software via communication interface 1520.

Software 1550 and remotely stored software may comprise an operating system, utilities, drivers, networking software, and other software typically executed by a computer system. Software 1550 may comprise an application program, applet, firmware, or other form of machine-readable processing instructions typically executed by a computer system. When executed by processing system 1530, software 1550 or remotely stored software may direct computer system 1500 to operate as described herein.

In an embodiment, an apparatus has a thumb-sized keyboard. The keyboard has at least one key for every letter of an alphabet. The apparatus also has an interface to couple a first indication of a first character associated with a first keystroke on the keyboard to a computer in real-time when the interface is in communication with the computer. The apparatus also has a memory interface to couple a second indication of a second character associated with a second keystroke on the keyboard to a removable memory device.

In another embodiment, the also has a display to provide a visible indication of the first character. The apparatus may couple the second indication retrieved from the removable memory device to the interface. The apparatus may couple the second indication to the interface for communication to the computer in response to a third keystroke. The apparatus may also have a thumbstick input device to provide two-dimensional input. The two-dimensional input may be relayed to the interface and to be reflected in real-time on a display of the computer.

The interface may comprise a wireless link. The interface may comprise an internet link. The interface may comprise a Universal Serial Bus link. Coupling the first indication of the first character associated with the first keystroke on the keyboard to a computer in real-time may result in the computer registering the first character in a currently selected program. Coupling the second indication to the interface may result in the computer registering the second character in a currently selected program. The second character may be registered in the currently selected program as a real-time keystroke on an attached keyboard.

A method of providing input to a computer may include receiving an indication of a keystroke associated with a first character from a thumb-sized keyboard. The keyboard may have at least one key for every letter of an alphabet. Via an interface, the first indication may be coupled to a computer in real-time while said interface is in communication with said computer. A second indication of a second character associated with a second keystroke on the keyboard may be coupled to a removable memory device via a memory interface. A visible indication of the first character may be displayed. The second indication may be retrieved from the removable memory device. The second indication may be coupled to the interface to be relayed to the computer as keyboard input. The second indication may be coupled to the interface is in response to a third keystroke.

Two-dimensional input may be received from a thumbstick input device. The two-dimensional input may be provided to the interface to be reflected in real-time on a display of the computer. The interface may comprise a wireless link. The interface may comprise an internet link. The interface may comprise a USB link. Coupling the first indication of the first character associated with the first keystroke on the keyboard to a computer in real-time may result in the computer registering the first character in a currently selected program. Coupling the second indication to the interface may result in the computer registering the second character in a currently selected program.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An apparatus, comprising:
a thumb-sized keyboard, said keyboard having at least one key for every letter of an alphabet;
an interface to couple a first indication of a first character associated with a first keystroke on said keyboard to a computer in real-time when said interface is in communication with said computer; and,
a memory interface to couple a second indication of a second character associated with a second keystroke on said keyboard to a removable memory device.

2. The apparatus of claim 1, further comprising:
a display to provide a visible indication of said first character.

3. The apparatus of claim 1, wherein said apparatus couples said second indication retrieved from said removable memory device to said interface.

4. The apparatus of claim 3, wherein said apparatus couples said second indication to said interface for communication to said computer in response to a third keystroke.

5. The apparatus of claim 1, further comprising:
a thumbstick input device to provide two-dimensional input, said two-dimensional input to be relayed to said interface and to be reflected in real-time on a display of said computer.

6. The apparatus of claim 1, wherein said interface comprises a wireless link.

7. The apparatus of claim 1, wherein said interface comprises an internet link.

8. The apparatus of claim 1, wherein said interface comprises a Universal Serial Bus (USB) link.

9. The apparatus of claim 1, wherein coupling said first indication of said first character associated with said first keystroke on said keyboard to a computer in real-time results in said computer registering said first character in a currently selected program.

10. The apparatus of claim 4, wherein coupling said second indication to said interface results in said computer registering said second character in a currently selected program.

11. The apparatus of claim 10, wherein said second character is registered in said currently selected program as a real-time keystroke on an attached keyboard.

12. A method of providing input to a computer, comprising:
receiving an indication of a keystroke associated with a first character from a thumb-sized keyboard, said keyboard having at least one key for every letter of an alphabet;
coupling, via an interface, said first indication to a computer in real-time while said interface is in communication with said computer; and,
coupling, to a removable memory device via a memory interface, a second indication of a second character associated with a second keystroke on said keyboard.

13. The method of claim 12, further comprising:
displaying a visible indication of said first character.

14. The method of claim 12, further comprising:
retrieving said second indication from said removable memory device; and,
coupling said second indication to said interface to be relayed to said computer as keyboard input.

15. The method of claim 14, wherein said coupling said second indication to said interface is in response to a third keystroke.

16. The method of claim 12, further comprising:
receiving two-dimensional input from a thumbstick input device; and,
providing said two-dimensional input to said interface to be reflected in real-time on a display of said computer.

17. The method of claim 14, wherein said interface comprises a wireless link.

18. The method of claim 14, wherein said interface comprises an interne link.

19. The method of claim 14, wherein said interface comprises a Universal Serial Bus (USB) link.

20. The method of claim 14, wherein coupling said first indication of said first character associated with said first keystroke on said keyboard to a computer in real-time results in said computer registering said first character in a currently selected program.

21. The method of claim 20, wherein coupling said second indication to said interface results in said computer registering said second character in a currently selected program.
